(19) United States
(12) Patent Application Publication
(10) Pub. No.: US 2002/0113018 A1
(43) Pub. Date: Aug. 22, 2002

(54) Composition for scavenging acylation reagents and/or aldehyde

(76) Inventor: Yoshiyuki Ono, Gotemba-shi (JP)

Correspondence Address: CHUGAI PHARMA USA, LLC, 6275 NANCY RIDGE DRIVE, SAN DIEGO, CA, 92121, US

(21) Appl. No.: 10/125,288

(22) Filed: Apr. 18, 2002

Related U.S. Application Data
(62) Division of application No. 09/617,579, filed on Jul. 17, 2000.

(51) Int. Cl. C02F 1/42

(52) U.S. Cl. 210/660; 210/679; 210/263; 210/749

(57) ABSTRACT

SiO₂—R (I)

Novel composition for scavenging acylation reagents and/or aldehyde and/or ketone, comprising amino functionalized silica gel of formula (I), useful for obtaining purified a compound.

### CROSS REFERENCE TO RELATED APPLICATIONS

This is a divisional application which is claiming priority to U.S. application Ser. No. 09/617,579, filed Jul. 17, 2000.

### FIELD OF THE INVENTION

This invention relates to a novel composition for scavenging acylation reagents and/or aldehyde and/or ketone comprising amino functionalized silica gel, a process for scavenging acylation reagents and/or aldehyde and/or ketone, and a scavenger having utility for purifying a compound to remove acylation reagents and/or aldehyde and/or ketone therefrom.

### BACKGROUND

The application of combinatorial chemistry technology to pharmaceutical drug discovery is becoming increasingly important. Through the application of combinatorial chemistry, large structurally diverse compound libraries can be rapidly generated, thereby saving time and effort in the drug discovery process (Thompson, L. A. and Eliman, J. A. Chem. Rev. (1996) 96,555-600).

In combinatorial library synthesis, two major synthetic methodologies have been developed. One is solid phase library synthesis (Eliman, J. A. and Plunkeft, M. J., J. Am. Chem. Soc. (1995) 117,3306-3307). The characteristic merit of solid phase synthesis is easy work-up and purification through simple washing and filtration. However, relatively few solid phase reactions have been optimized and considerable time and effort are often required for the development of new solid-phase library synthesis.

The other methodology is liquid phase library synthesis (Boger, D. L. et al., J. Am. Chem. Soc. (1996) 118, 2109-2110). This strategy involves the application of conventional organic synthesis and a large number of optimized reactions are available. Work-up and purification are, however, often tedious and time consuming. Convenient solid phase purification methods, using polystyrene scavenger resins have recently been developed (Kalder, S. W. et al., Bioorg. Med. Chem. Lett. (1996) 6,3041-3044, Kalder, S. W. et al., Tetrahedron Lett. (1996) 37, 7193-7196).

For instance, excess reagent in the reaction mixture can be captured by the functional group on a solid support through covalent bond or ionic bond formation and can be easily removed by simple filtration. Many functionalized polystyrene resins have been developed and are commercially available (Booth, R. J. and Hodges, J. C. J. Am. Chem. Soc. (1997) 119, 4882-4886). But the polystyrene-based resin is relatively expensive and there are still some limitations to large-scale library synthesis.

### SUMMARY OF THE INVENTION

The inventor has demonstrated that inexpensive amino functionalized silica gel can efficiently scavenge acylation reagents like acid chlorides, isocyanates and thioisocyanates. The amino functionalized silica gel is much more inexpensive than amino functionalized polystyrene resin when compared on a molar base. Although the adhesive character of polystyrene due to static electricity sometimes causes difficulty in handling of polystyrene-base resins, the amino functionalized silica gel can be very easily handled.

In one aspect, this invention encompasses a novel composition for scavenging acylation reagents and/or aldehyde and/or ketone comprising amino functionalized silica gel of formula (I),

SiO₂—R (I)

wherein

R is C₁ to C₁₀ linear, branched or cyclic alkyl and has at least one primary or secondary amino group.

Preferably, said acylation reagents are selected from one or more member of the group consisting of isocyanates, thioisocyanates and acid chlorides. Preferably, R is amino propyl group.

In another aspect, this invention encompasses a novel process for scavenging acylation reagents and/or aldehyde and/or ketone, comprising the steps of,

(i) contacting a solution comprising acylation reagents and/or aldehyde and/or ketone with amino functionalized silica gel of formula (I),

SiO₂—R (I)

wherein

R is C₁ to C₁₀ linear, branched or cyclic alkyl and has at least one primary or secondary amino group,

(ii) reacting said acylation reagents and/or aldehyde and/or ketone with said amino functionalized silica gel, and

(iii) removing said amino functionalized silica gel from said solution.

Preferably, acylation reagents are selected from one or more member of the group consisting of isocyanates, thioisocyanates and acid chlorides. Preferably, R is amino propyl group.

In a still further aspect, this invention encompasses a novel scavenger having utility for purifying a compound to remove acylation reagents and/or aldehyde and/or ketone therefrom, said scavenger comprising amino functionalized silica gel of formula (I),

SiO₂—R (I)

wherein

R is C₁ to C₁₀ linear, branched or cyclic alkyl and has at least one primary or secondary amino group.

Preferably, acylation reagents are selected from one or more member of the group consisting of isocyanates, thioisocyanates and acid chlorides. Preferably, R is amino propyl group.

### DETAILED DESCRIPTION OF THE INVENTION

Without being limited by the theory, it is thought that the composition comprising amino functionalized silica gel of this invention scavenges acylation reagents and/or aldehyde and/or ketone, and thus has utility for purifying a compound.

As used herein, “alkyl” means a hydrocarbon substituent which linear, branched or cyclic alkanyl or alkenyl. Alkyl is of 1 to about 10 carbons. Alkyl is selected from the group consisting of C₁, C₂, C₃, C₄, C₅, C₆, C₇, C₈, C₉, and C₁₀ alkyl, and preferred is C₃ alkyl. As used herein, “alkanyl” means a saturated hydrocarbon radical substituent, straight, cyclic or branched chain, unsubstituted or substituted. As used herein, “alkenyl” means a hydrocarbon substituent with one double bond, straight or branched chain, unsubstituted or substituted.

As used herein, “acylation reagent” means a reagent that participates in an acylation reaction to provide an activated or reactive —C═O group for the acylation reaction. Preferred acylation reagents are, for example, isocyanates, thioisocyanates and acid chlorides. “Isocyanate”, as used herein, means a chemical compound that has an —NCO group. “Thioisocyanate”, as used herein, means a chemical compound that has an —NCS group. “Acid chloride”, as used herein, means a chemical compound that has a —COCl group.

As used herein, “aldehyde” means a chemical compound that has an RCHO group and produces H₂O to form imine.

As used herein, “ketone” means a chemical compound that has an RCOR′ group and produces H₂O to form imine.

As used herein, “amino functionalized” means to have an capability of being reactive with acylation reagents and/or aldehyde and/or ketone through covalent bond via at least one primary or secondary amino group thereof.

As used herein, “silica gel” means a silicon compound having a formula of SiO₂. Silica gel may or may not be hydrated. Silica gel may be formed into a dried solid particle or also prepared in a liquid solution, such as slurry.

As used herein, “amino functionalized silica gel” means silica gel capable of being reactive with acylation reagents and/or aldehyde and/or ketone represented by the following general formula (I):

SiO₂—R (I)

wherein

R is C₁ to C₁₀ linear, branched or cyclic alkyl and has at least one primary or secondary amino group.

Preferred amino functionalized silica gel has amino propyl group as shown in the following formula (II):

SiO₂—(CH₂)₃—NH₂ (II)

Amino functionalized silica gel can be prepared using known methods. Preferably amino functionalized silica gel is dried before use, especially in the case of scavenging aldehyde and/or ketone. The dried silica gel can strongly absorb H₂O accompanied by imine formation. Conventional methods can be used to dry amino functionalized silica gel, e.g., by heating and evaporation.

As used herein, “scavenger” means a receptor of acylation reagents and/or aldehyde and/or ketone forming covalent bond to at least one primary or secondary amino group of the amino functionalized silica gel. A scavenger captures acylation reagents and/or aldehyde and/or ketone and therefore has utility for purifying desired a compound. A scavenger may form coating, plate, or bead which is functionalized.

This invention provides a composition for scavenging acylation reagents and/or aldehyde and/or ketone comprising amino functionalized silica gel of formula (I). The starting materials used in preparing the composition of this invention are known, made by known methods, or are commercially available as a starting material. It will be apparent to the skilled artisan that methods for preparing precursors, and functionality related to the composition claimed herein are generally described in the literature. The skilled artisan given the literature and this disclosure is well equipped to prepare any of the claimed compounds.

For instance, amino functionalized silica gel may be prepared using a method described in Carpino, L. A. et al., J.Org.Chem. 1983. 48(5), 666-669. The composition of this invention may further include aqueous solutions comprising an effective amount of a subject amino functionalized silica gel intended for the use. The composition of this invention may contain water or buffer to obtain slurry. Preferably the composition of this invention is dried before the use by any known means, e.g., heating and evaporation.

The composition of this invention further includes salt that is a cationic salt formed at any basic (e.g., amino) group. Many such salts are known in the art, as described in World Patent Publication 87/05297, Johnston et al., published Sep. 11, 1987 (incorporated by reference herein). Preferred cationic salts include the alkali metal salts (such as sodium and potassium), and alkaline earth metal salts (such as magnesium and calcium) and organic salts.

This invention provides a process for scavenging acylation reagents and/or aldehyde and/or ketone, comprising the steps of,

(i) contacting a solution comprising acylation reagents and/or aldehyde and/or ketone with amino functionalized silica gel of formula (I),

(ii) reacting said acylation reagents and/or aldehyde and/or ketone with said amino functionalized silica gel, and

(iii) removing said amino functionalized silica gel from said solution.

In order to scavenge acylation reagents and/or aldehyde and/or ketone, a liquid solution comprising acylation reagents and/or aldehyde and/or ketone is contacted the amino functionalized silica gel. The liquid solution comprising acylation reagents and/or aldehyde and/or ketone may be generated as a result of a reaction obtaining a compound generated using any manner.

After acylating reaction and/or a reaction to produce imine using aldehyde and/or ketone to give a desired compound, amino functionalized silica gel is added to scavenge an excess amount of acylation reagents and/or aldehyde and/or ketone. The reactions may be done in liquid phase synthesis or solid phase synthesis. Preferably the reactions are done in liquid phase synthesis. The reactions are done for preparing compound libraries generated using combinatorial chemistry techniques. Amino functionalized silica gel may be used when a volume of acylation reagents and/or aldehyde and/or ketone has a volume of 1.0 to 3.0 equivalents to that of the desired compound, preferably, 1.0 to 1.2 equivalents. Then, acylation reagents and/or aldehyde and/or ketone is reacted with amino functionalized silica gel.

In the preferred embodiment, for liquid phase use, the scavenging reaction is performed as a work-up, or under work-up conditions, such as incubating, mixing or stirring gently the liquid solution at an appropriate temperature after or during the addition of composition of this invention.

After the reactions are finished, amino functionalized silica gel is removed from the solution to give a purified compound. Amino functionalized silica gel that binds to acylation reagents and/or aldehyde and/or ketone through covalent bond is isolated, for example, filtrated with a filter to give purified a compound. Further to filtrating, centrifugating may be useful. After the isolation, a compound can be washed with an appropriate solvent, for example, dichloromethane (DCM).

In the preferred embodiment, for solid phase use, reaction products may be filtered through a bed or column of amino functionalized silica gel thereby scavenging the unused reagent, while allowing the desired products to pass through.

This invention provides a scavenger having utility for purifying a compound to remove acylation reagents and/or aldehyde and/or ketone therefrom, said scavenger comprising amino functionalized silica gel of formula (I). The scavenger of this invention is used for scavenging acylation reagents and/or aldehyde and/or ketone. Mixtures comprising acylation reagents and/or aldehyde and/or ketone and a desired compound are purified by removing acylation reagents and/or aldehyde and/or ketone therefrom by the scavenger of this invention. Therefore, the scavenger of this invention is useful for purifying a desired compound.

### EXAMPLES

To further illustrate this invention, the following examples are included. The examples should not, of course, be construed as specifically limiting the invention. Variations of these examples within the scope of the claims are within the purview of one skilled in the art are considered to fall within the scope of the invention as described, and claimed herein. The reader will recognize that the skilled artisan, armed with the present disclosure, and skill in the art is able to prepare and use the invention without exhaustive examples.

Trademarks used herein are examples only and reflect illustrative materials used at the time of the invention. The skilled artisan will recognize that variations in lot, manufacturing processes, and the like, are expected. Hence the examples, and the trademarks used in them are non-limiting, and they are not intended to be limiting, but are merely an illustration of how a skilled artisan may choose to perform one or more of the embodiments of the invention.

### Example 1

### Scavenging of Isocyanates

0.644 mmol of isocyanate (83.5 μl), 1.2 equivalents to the Boc-piperazine, was added to 0.537 mmol of the Boc-piperazine (100 mg) in 2 ml DCM solution in four containers and mixed for 20 minutes at a room temperature.

In each container, added were (i) nothing (as negative control), (ii) 259 mg of normal silica gel (without amino group functionalization), (iii) 259 mg of amino functionalized silica gel (0.215 mmol), 0.4 equivalents to the normal silica gel, or (iv) 49 mg of amino polystyrene resin (0.215 mmol), 0.4 equivalents to the normal silica gel. Thus, two equivalents of (iii) and (iv) were added into an excess amount of the isocyanate. These containers were incubated for 20 minutes. After filtration, the resultant solution was washed twice with 2 ml of DCM and evaporated to obtain the desired compound.

The eluents were subjected to thin layer chromatography. The isocyanate was removed by amino functionalized silica gel in (iii), while the isocyanate was detected at the starting spots of the other groups (i), (ii) and (iv). Yields were 193 mg for (i), 167 mg for (ii), 178 mg (99% recovery) for (iii), and 180 mg for (iv). The following is an analytical result of the purified compound with amino functionalized silica gel in (iii). ¹H NMR(CDCl₃, 400 Hz) 1.46 (s, 9H), 3.44-3.50 (m, 8H), 3.77 (s, 3H), 6.20 (brs, 1H), 6.83 (d, J=9.0 Hz, 2H), 7.22 (d, J=9.0 Hz, 2H) MS m/z 335.8 (C₁₇H₂₅N₃O₄ requires 335.2) HPLC analysis 100%.

This result shows that amino functionalized silica gel efficiently scavenges isocyanates.

### Example 2

### Scavenging of Acid Chlorides

300 mg of Dowex 550A OH anion exchange resin and 0.644 mmol of acid chloride (100.4 μl), 1.2 equivalents to the Boc-piperazine, were added to 0.537 mmol of the Boc-piperazine (100 mg) in 2 ml DCM solution in four containers and mixed for 20 minutes at a room temperature.

In each container, added were (i) nothing (as negative control), (ii) 259 mg of normal silica gel (without amino group functionalization), (iii) 259 mg of amino functionalized silica gel (0.215 mmol), 0.4 equivalents to the normal silica gel, or (iv) 49 mg of amino polystyrene resin (0.215 mmol), 0.4 equivalents to the normal silica gel. Thus, two equivalents of (iii) and (iv) were added into an excess amount of the acid chloride. These containers were incubated for 20 minutes. After filtration, the resultant solution was washed twice with 2 ml of DCM and evaporated.

The eluents were subjected to thin layer chromatography. The acid chloride was removed by amino functionalized silica gel in (iii), while the acid chloride was detected at the starting spots of the other groups (i), (ii) and (iv). Yields were 203 mg for (i), 184 mg for (ii), 173 mg (97% recovery) for (iii), and 199 mg for (iv). The following is an analytical result of purified compound with amino functionalized silica gel in (iii). ¹H NMR(CDCl₃, 400 Hz) 1.42 (s, 9H), 3.20 (t, J=4.9 Hz, 2H), 3.34-3.38 (m, 4H), 3.50 (t, J=5.0 Hz, 2H), 3.70 (s, 2H), 3.77 (s, 3H), 7.19-7.24 (m, 1H) MS m/z 334.9 (C₁₆H₂₆N₂O₄ requires 334.2) HPLC analysis 94%.

This result shows that amino functionalized silica gel efficiently scavenges acid chloride.

### Example 3

### Scavenging of Aldehydes

In each container, to 1 ml DCM solution of 4-methoxyphenylaldehyde (10.0 ml, 0.082 mmol), added were (i) nothing (as negative control), (ii) 297 mg of amino functionalized silica gel (0.247 mmol, 3.0 equivalents to aldehyde) which was dried at 100 dgrC, (iii) 297 mg of normal silica gel which was dried at 100 dgrC for 3 hours, or (iv) 54 mg of amino functionalized polystyrene resin (0.247 mmol, 3.0 equivalents to aldehyde). These containers were incubated for 13 hours. Small amount of reaction mixtures was filtrated.

The eluents were subjected to thin layer chromatography. The aldehyde was removed by amino functionalized silica gel in (ii), while aldehyde was detected at the starting spots of the other groups (i), (iii) and (iv).

This result shows that amino functionalized silica gel efficiently scavenges aldehyde.

Thus, amino functionalized silica gel can efficiently scavenge acylation reagents like acid chlorides, isocyanates and thioisocyanates, and aldehydes.

Modification of the proceeding embodiments is within the scope of the skilled artisan in formulation, given the guidance of the specification in light of the state of the art.

All references described herein are hereby incorporated by reference.

While particular embodiments of this invention have been described, it will be obvious to those skilled in the art that various changes and modifications of this invention can be made without departing from the spirit and scope of the invention. It is intended to cover, in the appended claims, all such modifications that are within the scope of this invention.

What is claimed:

1. A composition for scavenging acylation reagents and/or aldehyde and/or ketone comprising amino functionalized silica gel of formula (I),
SiO₂—R (I)
wherein
R is C₁ to C₁₀ linear, branched or cyclic alkyl and has at least one primary or secondary amino group.

2. A composition of claim 1, wherein said acylation reagents are selected from one or more member of the group consisting of isocyanates, thioisocyanates and acid chlorides.

3. A composition of claim 1, wherein R is amino propyl group.

4. A process for scavenging acylation reagents and/or aldehyde and/or ketone, comprising the steps of,
(i) contacting a solution comprising acylation reagents and/or aldehyde and/or ketone with amino functionalized silica gel of formula (I),
SiO₂—R (I)
wherein
R is C₁ to C₁₀ linear, branched or cyclic alkyl and has at least one primary or secondary amino group,
(ii) reacting said acylation reagents and/or aldehyde and/or ketone with said amino functionalized silica gel, and
(iii) removing said amino functionalized silica gel from said solution.

5. A process of claim 4, wherein said acylation reagents are selected from one or more member of the group consisting of isocyanates, thioisocyanates and acid chlorides.

6. A process of claim 4, wherein R is amino propyl group.

7. A scavenger having utility for purifying a compound to remove acylation reagents and/or aldehyde and/or ketone therefrom, said scavenger comprising amino functionalized silica gel of formula (I),
SiO₂—R (I)
wherein
R is C₁ to C₁₀ linear, branched or cyclic alkyl and has at least one primary or secondary amino group.

8. A scavenger of claim 7, wherein said acylation reagents are selected from one or more member of the group consisting of isocyanates, thioisocyanates and acid chlorides.

9. A scavenger of claim 7, wherein R is amino propyl group.
